(19) United States
(12) Patent Application Publication
(10) Pub. No.: US 2025/0181621 A1
(43) Pub. Date: Jun. 5, 2025

(54) METHOD AND APPARATUS FOR SEARCHING DATA IN E-BOOK READER, DEVICE, AND MEDIUM

(71) Applicant: Beijing Zitiao Network Technology Co., Ltd., Beijing (CN)

(72) Inventors: Yifan ZHU, Beijing (CN); Guibo PAN, Beijing (CN); Wei LUO, Beijing (CN)

(21) Appl. No.: 18/929,448

(22) Filed: Oct. 28, 2024

(30) Foreign Application Priority Data
Dec. 4, 2023 (CN) 202311651880.4

(51) Int. Cl. G06F 16/334; G06F 16/31; G06F 40/30

(52) U.S. Cl. CPC G06F 16/3344; G06F 16/313; G06F 40/30

(57) ABSTRACT

Provided are a method and an apparatus for searching data in an e-book reader, a device, and a medium. The method includes: in response to a search request, identifying a search intent of a user based on the search request; determining, based on the search intent, a first weight of a first index and a second weight of a second index in a plurality of indexes of a database of the e-book reader; determining, by using the first index and the second index, a first sequence of search resultsand a second sequence of search resultsthat match the search request; and providing at least a portion of the search results in the first sequence of search resultsand the second sequence of search resultsbased on the first weight and the second weight.

### CROSS-REFERENCE

The present application claims priority to Chinese Patent Application 202311651880.4, filed on Dec. 4, 2023 and entitled “METHOD AND APPARATUS FOR CREATING APPLICATION, DEVICE AND STORAGE MEDIUM”, the entirety of which is incorporated herein by reference.

### FIELD

Various implementations of the present disclosure relate to the field of computers, and in particular, to a method and an apparatus for searching data in an e-book reader, a device, and a computer-readable storage medium.

### BACKGROUND

With the development of digital technologies, more and more applications and websites may be used to present various types of media data (for example, articles, e-books, comments, and the like). A user may select content of interest in the applications and/or websites for reading. In order to allow the user to find the content of interest conveniently and quickly, the applications and/or websites also often provide data search services. The applications and/or websites may search for media data based on a keyword input by a user to find the content of interest to the user. However, the accuracy of the existing search solutions is not satisfactory, and it is expected to improve the accuracy of data search.

### SUMMARY

In a first aspect of the present disclosure, a method for searching data in an e-book reader is provided. In the method, in response to a search request, a search intent of a user is identified based on the search request; a first weight and a second weight of a first index and a second index respectively, of a plurality of indexes of a database of the e-book reader are determined based on the search intent; a first sequence of search results and a second sequence of search results that match the search request are determined by using the first index and the second index respectively; and at least a portion of search results in the first sequence of search results and the second sequence of search results are provided based on the first weight and the second weight.

In a second aspect of the present disclosure, an apparatus for searching data in an e-book reader is provided. The apparatus includes: an identification module, configured to, in response to a search request, identify a search intent of a user based on the search request; a weight determination module, configured to determine, based on the search intent, a first weight and a second weight of a first index and a second index respectively, of a plurality of indexes of a database of the e-book reader; a sequence determination module, configured to determine, by using the first index and the second index respectively, a first sequence of search results and a second sequence of search results that match the search request; and a providing module, configured to provide at least a portion of search results in the first sequence of search results and the second sequence of search results based on the first weight and the second weight.

In a third aspect of the present disclosure, an electronic device is provided. The electronic device includes: at least one processing unit; and at least one memory coupled to the at least one processing unit and storing instructions for execution by the at least one processing unit, the instructions, when executed by the at least one processing unit, causing the electronic device to perform the method according to the first aspect of the present disclosure.

In a fourth aspect of the present disclosure, a computer-readable storage medium having a computer program stored thereon is provided, the computer program, when executed by a processor, causing the processor to implement the method according to the first aspect of the present disclosure.

It should be understood that the content described in this section of the content is not intended to limit the key or important features of implementations of the present disclosure, nor is it intended to limit the scope of the present disclosure. Other features of the present disclosure will become readily understandable through the following description.

### BRIEF DESCRIPTION OF THE DRAWINGS

Hereinafter, the above and other features, advantages, and aspects of implementations of the present disclosure will become more apparent with reference to the following detailed description in combination with the accompanying drawings. In the drawings, the same or similar reference numerals denote the same or similar elements, where:

FIG. 1 shows a schematic diagram of an example environment in which implementations of the present disclosure may be implemented;

FIG. 2 schematically shows a block diagram of a process of searching data in an e-book reader according to some implementations of the present disclosure;

FIG. 3 schematically shows a block diagram of a storage system according to some implementations of the present disclosure;

FIG. 4 schematically shows a block diagram of a search and update process according to some implementations of the present disclosure;

FIG. 5 schematically shows a block diagram of determining a search intent according to some implementations of the present disclosure;

FIG. 6 schematically shows a block diagram of a process of updating an index according to some implementations of the present disclosure;

FIG. 7 schematically shows an example of a result page according to some implementations of the present disclosure;

FIG. 8 shows a flowchart of a method for searching data in an e-book reader according to some implementations of the present disclosure;

FIG. 9 shows a block diagram of an apparatus for searching data in an e-book reader according to some implementations of the present disclosure; and

FIG. 10 shows a block diagram of a device capable of implementing a plurality of implementations of the present disclosure.

### DETAILED DESCRIPTION

Implementations of the present disclosure will be described in more detail below with reference to the accompanying drawings. Although some implementations of the present disclosure are shown in the drawings, it should be understood that the present disclosure may be implemented in various forms and should not be construed as being limited to the implementations set forth herein. Rather, these implementations are provided for a more thorough and complete understanding of the present disclosure. It should be understood that the accompanying drawings and implementations of the present disclosure are only for exemplary purposes and are not intended to limit the scope of protection of the present disclosure.

In the description of implementations of the present disclosure, the term “include/comprise” and similar terms should be understood as an open inclusion, that is, “include/comprise but not limited to”. The term “based on” should be understood as “at least partially based on”. The term “an implementation” or “the implementation” should be understood as “at least one implementation”. The term “some implementations” should be understood as “at least some implementations”. The terms “first”, “second”, and the like may refer to different or the same objects. Other definitions, either explicit or implicit, may be included below.

It may be understood that the data involved in the technical solutions of the present disclosure (including but not limited to the data itself, data acquisition or use) should comply with the requirements of corresponding laws, regulations and related provisions.

It may be understood that before using the technical solutions disclosed in the implementations of the present disclosure, the user should be informed of the type, scope of use, usage scenarios, and the like of personal information involved in the present disclosure in an appropriate manner in accordance with relevant laws and regulations and obtain the user's authorization.

For example, when receiving an active request from a user, a prompt message is sent to the user to explicitly prompt the user that the operation requested by the user will need to acquire and use the user's personal information. Therefore, the user can independently choose whether to provide personal information to the software or hardware, such as an electronic device, an application, a server, or a storage medium, that performs the operation of the technical solution of the present disclosure based on the prompt information.

As an optional but non-limiting implementation, the manner of sending a prompt message to the user in response to receiving the active request from the user, for example, may be a pop-up window, and the prompt message may be presented in the pop-up window in text. In addition, the pop-up window may also carry a selection control for the user to select “agree” or “disagree” to provide personal information to the electronic device.

It may be understood that the above notification and user authorization process is merely illustrative and does not limit the implementations of the present disclosure. Other manners that meet relevant laws and regulations may also be applied to the implementations of the present disclosure.

The term “in response to” used herein indicates a state in which a corresponding event occurs or a condition is satisfied. It will be understood that the timing of execution of the subsequent action executed in response to the event or condition and the time when the event occurs or the condition is established are not necessarily strongly correlated. For example, in some cases, the subsequent action may be executed immediately upon the occurrence of the event or the establishment of the condition; while in other cases, the subsequent action may be executed after a period of time after the event occurs or the condition is established.

### Example Environment

FIG. 1 shows a schematic diagram of an example environment 100 in which implementations of the present disclosure may be implemented. In the environment 100, a user 110 may provide a search request 120 to a storage system 130. The search request 120 may include, for example, a keyword entered by the user for searching data.

The storage system 120 includes an index 132 and a repository 134. The index 132 may be used to store data items and corresponding location information, for example. For example, the index 132 may be used to store location information of a keyword in the repository 134. A large amount of data may be stored in the repository 134. For ease of description, in the context of the present disclosure, an example in which the user 110 intends to search for a related data item of an e-book is taken. The repository 134 may include at least a large amount of data associated with the e-book.

Based on the search request 120, a data item that matches the search request 120 may be obtained from the repository 134 based on the data item and corresponding location information indicated in the index 132. The data item may be used as a search result 140, and may be provided to the user 110.

The storage system 130 may run on any appropriate electronic device. The electronic device here may be any type of device with computing capabilities, including a terminal device or a server device. The terminal device may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a TV receiver, a radio broadcast receiver, an e-book device, a gaming device, or any combination thereof, including accessories and peripherals of these devices or any combination thereof. The server device may include, for example, a computing system/server, such as a mainframe computer, an edge computing node, a computing device in a cloud environment, and the like. In some implementations, the storage system 130 may be implemented based on a cloud service.

It should be understood that the structure and function of the environment 100 are described for exemplary purposes only, without implying any limitation on the scope of the present disclosure.

As discussed above, applications and/or websites may provide data search services. The applications and/or websites may search for related data of an e-book based on a keyword entered by a user to find the content of interest to the user. Conventionally, each paragraph of an e-book is often segmented into words according to a fixed rule and stored in an inverted index. When performing data search, the related content is retrieved from the repository through the inverted index based on the keyword, and the results are ranked according to the text correlation score. That is, the conventional search systems are often based on simple and fixed word segmentation rules, and then the text in the index is matched and ranked according to the text correlation and returned to the user.

However, the search solution based on content text correlation matching alone may not understand the user intent, and the content returned by a single index is limited, which may affect the search accuracy and may result in a difference between the search result and the content actually required by the user. In addition, when the volume of the repository exceeds a certain level, the large amount of data and high resource costs will affect search efficiency because all content needs to be segmented and indexed. Further, the real-time degree of index update becomes low, which may also affect search accuracy. In addition, the conventional data search solution only supports full-text search within a book, and may not search for other related data based on a search request entered by the user.

### Process of Searching Data

In order to at least partially solve the deficiencies in the prior art, according to some example implementations of the present disclosure, a method for searching data in an e-book reader is proposed. In summary, in response to a search request, a search intent of a user is identified based on the search request. A first weight of a first index and a second weight of a second index in a plurality of indexes of a database of the e-book reader are determined based on the search intent. A first sequence of search results and a second sequence of search results that match the search request are determined by using the first index and the second index. At least a portion of search results in the first sequence of search results and the second sequence of search results are provided based on the first weight and the second weight.

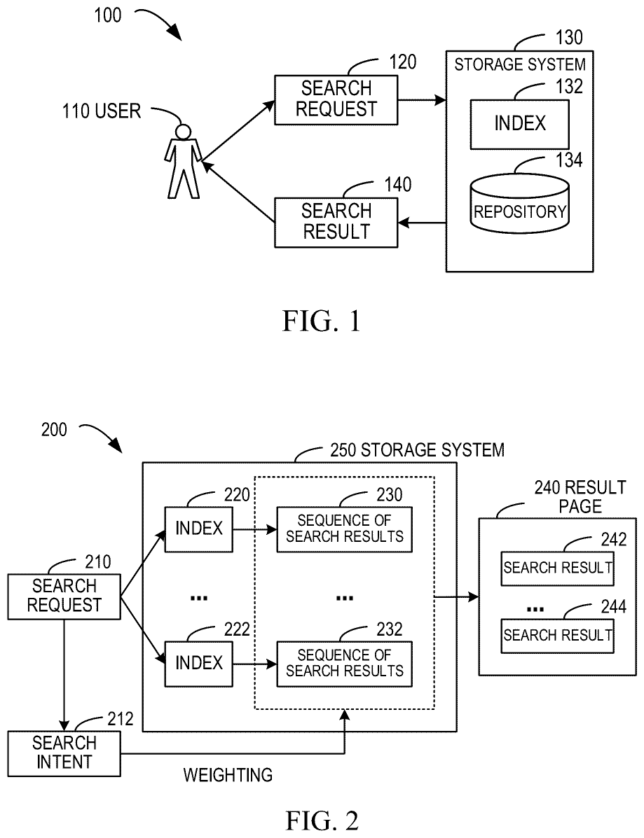

Reference is made to FIG. 2 to describe an example implementation according to the present disclosure. FIG. 2 schematically shows a block diagram 200 of a process of searching data in an e-book reader according to some implementations of the present disclosure. As shown in FIG. 2, a search may be performed in parallel by using a plurality of indexes in a storage system 250 according to a search request 210. The storage system 250 may include the plurality of indexes. The plurality of indexes may be, for example, indexes created according to at least one of the following: a character in an e-book, a main character in the e-book, a time in the e-book, a place in the e-book, an event in the e-book, a title in the e-book, a plot in the e-book, a paragraph in the e-book, an important paragraph in the e-book, a bookmark in the e-book, a note in the e-book, usage history data of the e-book, and comment data of the e-book.

According to an example implementation of the present disclosure, corresponding sequence of search resultss may be obtained based on each index. For example, a sequence of search results 230 may be obtained based on an index 220, . . . , and a sequence of search results 232 may be obtained based on an index 222. Each search result in the sequence of search resultss may have a score. Further, a weight of each index may be determined according to a search intent 212, and scores of respective search results in each sequence of search results may be weighted by using the respective weights. Therefore, search results 242, 244, and the like ranked according to the weighted scores may be presented in a result page 240. In this way, search results that match the search intent 212 of the user may be preferentially presented, thereby improving search accuracy.

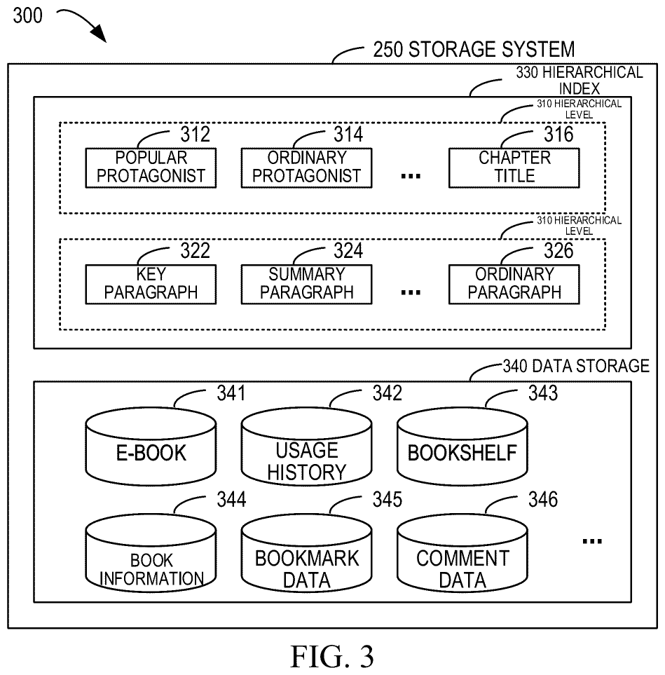

In some implementations, in order to classify the plurality of indexes, the storage system 250 may include a hierarchical index. FIG. 3 schematically shows a block diagram 300 of a storage system 250 according to some implementations of the present disclosure. As shown in FIG. 3, the storage system 250 may include a hierarchical index 330 and a data storage 340. The data storage 340 may correspond to the repository 134 in FIG. 1, for example.

In the storage system 250, for example, different indexes may be classified to determine the hierarchical index 330. The hierarchical index 330 may include a plurality of hierarchical levels. For example, the hierarchical index 330 may include a hierarchical level 310 and a hierarchical level 320. Different hierarchical levels may include different types of indexes. For example, the hierarchical level 310 may include an index corresponding to a popular protagonist 312, an index corresponding to an ordinary protagonist 314, an index corresponding to a chapter title 316, and the like. The hierarchical level 320 may include an index corresponding to an important paragraph 322, an index corresponding to a summary paragraph 324, an index corresponding to an ordinary paragraph 326, and the like. It should be noted that the hierarchical index 330 may include more or fewer hierarchical levels, and each hierarchical level may also include any appropriate index. FIG. 3 shows only an example, and the present disclosure does not limit the specific number of hierarchical levels and the index included in each hierarchical level.

In some implementations, the storage system 250 may include data such as an e-book, an audio e-book, information of the e-book, usage history data of the e-book, bookmark data in the e-book, and comment data of the e-book. Specifically, the data storage 340 of the storage system 250 may include, for example, a plurality of databases or data tables corresponding to different data items, and the like. For example, the data storage 340 may include a database corresponding to an e-book 341, a database corresponding to a usage history 342, a database corresponding to a bookshelf 343, a database corresponding to book information 344, a database corresponding to bookmark data 345, a database corresponding to comment data 346, and the like.

According to an example implementation of the present disclosure, the search intent 212 of the user may be identified based on the search request 210. The search intent 212 may correspond to, for example, at least one data item of data in the storage system 250. For example, if the search request 210 entered by the user includes a keyword A, the search intent 212 may indicate at least one data item corresponding to the keyword A in the repository. In some implementations, the search intent 212 may be determined based on an intent model. For example, the intent model may be implemented based on a machine learning technology, and the present disclosure does not limit the specific model.

The intent model may include, for example, an intent identification model. The intent identification model may describe an association relationship between the search request and at least one data item expected to be searched for specified by the search request. In some implementations, text processing may be performed on the search request 210 before intent identification is performed. For example, redundant information (for example, an interjection) and the like in the search request 210 may be filtered, and the search intent 212 may be determined based on the search request 210 and by using the intent identification model.

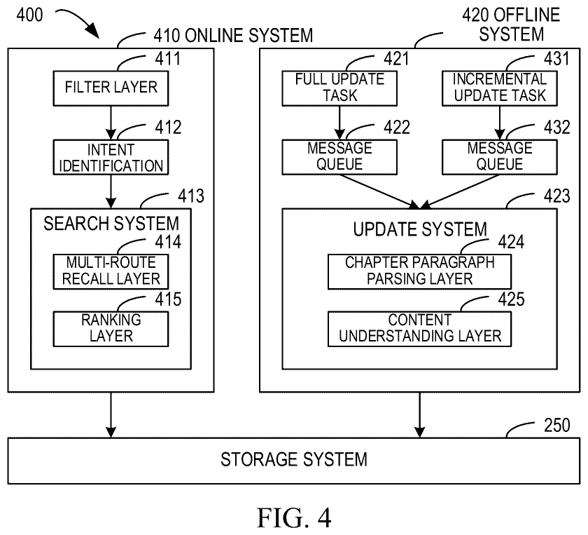

FIG. 4 schematically shows a block diagram 400 of a search and update process according to some implementations of the present disclosure. As shown in FIG. 4, an online system 410 may be provided to serve user searches, and an offline system 420 may be provided to be responsible for updating various indexes. The online system 410 includes a filter layer 411. In response to obtaining a search request 210 entered by the user, the filter layer 411 may perform filtering processing on the search request. Specifically, the filter layer 411 may determine whether the search request 210 conforms to a predetermined grammar specification. Further, the search intent 212 corresponding to the search request 210 may be determined by using the intent identification model.

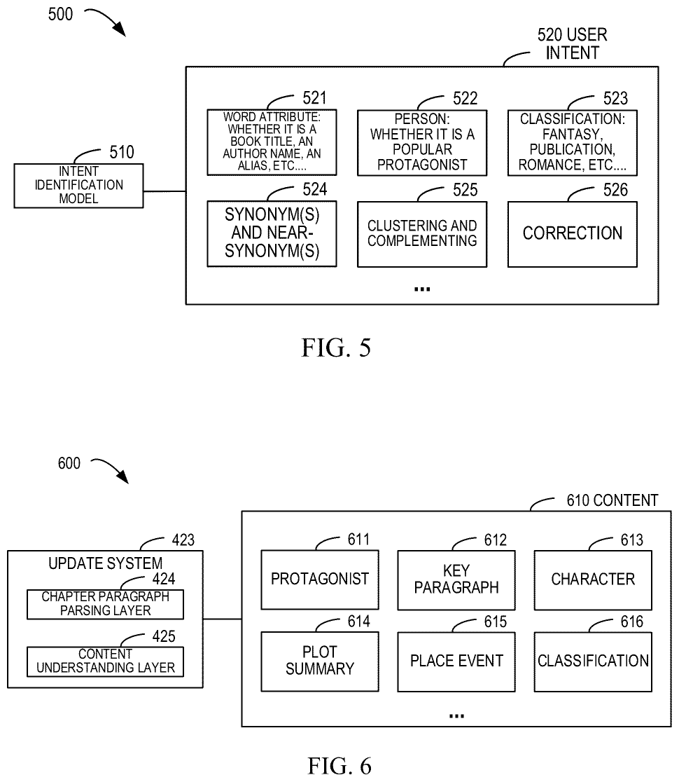

Reference is made to FIG. 5 to describe more details of the intent identification. FIG. 5 schematically shows a block diagram 500 of determining a search intent according to some implementations of the present disclosure. As shown in FIG. 5, the filtered search request may be provided to an intent identification model 510. The intent identification model 510 may determine a user intent 520 corresponding to the search request. The user intent 520 may determine, for example, a word attribute 521 of the search request (for example, whether it is a book title, an author name, an alias, etc.). When the search request indicates that a keyword associated with a person is included, the intent identification model 510 may also determine whether the person is a popular protagonist 522. The intent identification model 510 may also determine a classification 523 of a book indicated by the search request (for example, fantasy, publication, romance, etc.), synonym(s) and near-synonym(s) 524 associated with the search request, and the like. The intent identification model 510 may also perform clustering and complementing 525 and correction 526 on the search request, and the like.

Reference is returned to FIG. 4 to describe more details of the online system 410. As shown in FIG. 4, in a search system 413, a multi-route recall layer 414 may be used to call each index to determine a sequence of search results corresponding to each index from a repository (not shown) of the storage system 250. That is, the sequence of search results that matches the search request 210 may be determined by using each index. For example, taking an index 220 (that is, a first index) and an index 222 (that is, a second index) as an example, a sequence of search results 230 (that is, a first sequence of search results) corresponding to the index 220 and a sequence of search results 232 (that is, a second sequence of search results) corresponding to the index 222 may be determined from the repository.

It may be understood that the first index and the second index here are only specific examples of indexes. In the context of the present disclosure, there may be more indexes. Specifically, a larger number of indexes may also be determined based on the search request 210. The two indexes here are only examples, and the present disclosure does not limit the specific number of indexes. In the case where a larger number of indexes are determined, a larger number of sequence of search resultss may be determined.

Further, a ranking layer 415 may be used to rank search results from the multi-route recall layer 414. According to an example implementation of the present disclosure, the sequence of search results from each index may include a plurality of search results, and each search result may have a respective score.

In some implementations, a search range of the search request may also be determined based on context information of the user inputting the search request, and each sequence of search results that matches the search request 210 may be determined by using each index in the search range. It may be understood that both the at least one index and the at least one sequence of search results are in line with the search range. For example, the context information may indicate that the user is reading a certain book, and in this case, the search may be performed within the scope of the book. For another example, the context information may indicate that the user is browsing book comments, and in this case, the search may be performed within the scope of the book comments. For another example, the context information may indicate that the user has just logged in to an e-book application, and in this case, the search may be performed within the entire scope of the application, and the like.

According to an example implementation of the present disclosure, the weight of each index may be determined based on the determined intent, and then the weighted score of each search result may be determined. Further, each search result may be ranked according to the weighted score to determine the final result provided to the user. For example, a predetermined number of search results with the highest score may be selected.

Specifically, each search result obtained may be weighted based on the search intent 212. As mentioned above, the search intent corresponds to at least one data item of data in the storage system 250. For each of the at least one index, at least one match degree between the data item of the index and the at least one data item may be determined, and the weight corresponding to the index is determined based on the at least one match degree. The match degree here may be determined, for example, using a matching degree determination model or determined using a predefined matching degree determination rule. The weight corresponding to each index may be, for example, inherited by the sequence of search results corresponding to the index. That is, a weight corresponding to the first sequence of search results determined based on the first index is the weight of the first index. Alternatively or additionally, in some implementations, the weight corresponding to each sequence of search results in the at least one sequence of search results may also be directly determined based on the search intent 212. In this way, a higher weight may be set for a search result that more closely matches the search intent, so that the search result is preferentially presented.

According to an example implementation of the present disclosure, the at least one sequence of search results may be weighted based on the determined weight corresponding to the at least one index or the weight corresponding to the at least one sequence of search results. For example, the weight corresponding to the index 220 and the weight corresponding to the index 222 may be determined based on the search intent 212, the sequence of search results 230 is weighted based on the weight corresponding to the index 220, and the sequence of search results 232 is weighted based on the weight corresponding to the index 222. Alternatively, the weight corresponding to the sequence of search results 230 and the weight corresponding to the sequence of search results 232 may be directly determined, and the sequence of search results 230 and the sequence of search results 232 are respectively weighted based on the respective weights.

According to an example implementation of the present disclosure, each search result may be ranked according to the match degree with the search request. In this case, a search result with a higher ranking may have a higher score, and a search result with a lower ranking may have a lower score. The score of each search result may be weighted. In this way, the score of each search may be determined in a simple and effective manner, thereby helping to preferentially present the search result with the highest score.

Each sequence of search results may include a plurality of search results. At least one search result corresponding to the search request 210 may be determined based on the at least one weighted sequence of search results. In some implementations, for the convenience of the user to view, the at least one search result corresponding to the search request 210 may be presented in the result page 240. For example, a search result 242 and a search result 244 may be presented in the result page 240.

In some implementations, a global position corresponding to each search result may also be determined to rank the search results. All data items associated with the search request 210 are determined from the storage system 250. As an example, the multi-route recall layer 414 is configured to determine a plurality of sequence of search resultss based on the plurality of indexes. The ranking layer 415 may determine the global position of each search result in the plurality of sequence of search resultss to rank all search results included in the at least one sequence of search results.

Specifically, the ranking layer 415 may determine the global position of the search result based on a local position of each search result in a corresponding sequence of search results and a weight corresponding to the sequence of search results (for example, the global position is determined based on the weighted score described above). Further, in global search results used to respond to the search request 210, the ranking layer 415 may present the target search result based on the global position. For example, the higher the weighted score is, the higher the global position is. In this way, search results that the user is more interested in may be determined in a simple and effective manner, thereby improving search efficiency.

The process of performing search using the online system 410 has been described. The process of updating the index using the offline system 420 is described below. In some implementations, in response to data updating in the storage system 250 (that is, data in the repository), the plurality of indexes in the storage system 250 may be updated. In some implementations, at least one index involved in the data updating in the plurality of indexes may be updated based on a full update mode and/or an incremental update mode. In the full update mode, the plurality of indexes may be updated based on data updated in the storage system 250 in a predetermined period of time (for example, one day). In the incremental update mode, a corresponding index may be updated based on updated data in response to a certain data update in the storage system 250. In this case, if a certain data is added/deleted, the corresponding index may be adjusted accordingly.

As shown in FIG. 4, in the offline system 420, a full update task 421 may be performed to obtain a message queue 422. An incremental update task 431 may also be performed to obtain a message queue 432. The message queue 422 indicates each task for performing a full update, and the message queue 432 indicates each task for performing an incremental update. For example, both may indicate which data is updated and which update is made. The offline system 420 also includes an update system 423. The message queue 422 and the message queue 432 are provided to the update system 423 to indicate the update system 423 to update the index. The update system 423 may include a chapter paragraph parsing layer 424 and a content understanding layer 425.

Reference is made to FIG. 6 to describe more details related to updating the index. FIG. 6 schematically shows a block diagram 600 of a process of updating an index according to some implementations of the present disclosure. As shown in FIG. 6, the chapter paragraph parsing layer 424 and the content understanding layer 425 in the update system 423 may determine content 610 corresponding to the updated data based on the message queue 422 and/or the message queue 432. For example, it may be determined which content the updated data corresponds to, e.g., a protagonist 611, an important paragraph 612, a character 613, a plot summary 614, a place event 615, a classification 616, and the like. The update system 420 may then update the index based on the determined content.

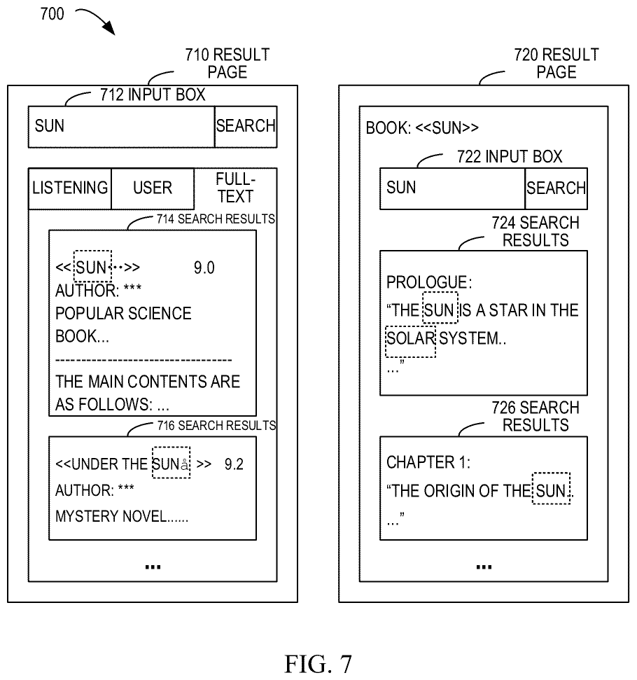

According to an example implementation of the present disclosure, the above-described method may be implemented in an e-book reader. In this way, it is convenient to improve the efficiency of readers in finding e-book related information. Reference is made to FIG. 7 to describe more details of performing search in an e-book reader. FIG. 7 schematically shows an example 700 of a result page according to some implementations of the present disclosure. As shown in FIG. 7, search may be performed on a home page of the e-book reader. For example, if all books are to be searched for, a result page 710 may be provided. The user may enter a search request in an input box 712. At this time, search results (for example, search results 714 and search results 716, etc.) corresponding to the search request “sun” entered by the user in the input box 712 and obtained by searching in all e-books are presented in the result page 710.

For another example, the user may enter a search request in an input box 722 when reading a certain book (for example, a book “Sun . . . ”), and in this case, content included in the book may be searched for, and then a result page 720 may be provided. Search results (for example, search results 724 and search results 726, etc.) corresponding to the search request “sun” entered by the user in the input box 722 and obtained by searching in the book are presented in the result page 720.

According to an example implementation of the present disclosure, the user is allowed to further interact with the search results. In response to detecting a user interaction of the user for a target search result in at least a portion of search results, detailed data including the target search result is provided. For example, assuming that the user presses the search result 714 in the result page 710, a found book “Sun . . . ” may be presented in a subsequent page. For another example, assuming that the user presses the search result 724 in the result page 720, a preface part of the book may be presented in a subsequent page, and the like. In this way, the user is allowed to quickly view more information of the search result, thereby facilitating the user to find more interested content.

According to an example implementation of the present disclosure, the user may close the detailed data. In response to detecting a close request for closing the detailed data, a page for providing the at least the portion of search results, that is, the result page 710 or 720 shown in FIG. 7, may be returned. In this way, the user is allowed to perform flexible switching between the result page and the detailed information, thereby facilitating the user to find more interested content.

According to the implementations of the present disclosure, intent identification may be performed on a search request entered by a user to determine a search intent corresponding to the search request, and the weight of each index and/or the corresponding sequence of search results may be determined based on the search intent. The at least one sequence of search results may be weighted based on the weight, thereby determining a search result that matches the search intent of the user, which helps to improve search accuracy. In addition, the use of a hierarchical index and two systems, that is, an online system and an offline system, may help improve search efficiency and content update efficiency.

### Example Process

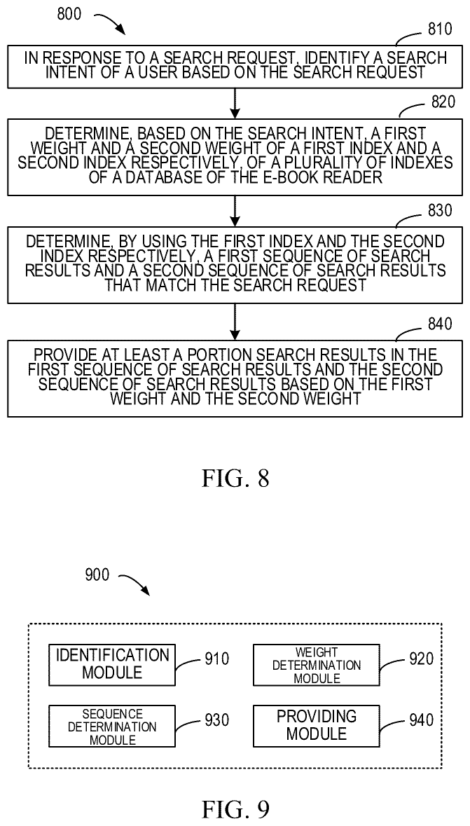

FIG. 8 shows a flowchart of a method 800 for searching data in an e-book reader according to some implementations of the present disclosure. At block 810, in response to a search request, a search intent of a user is identified based on the search request. At block 820, a first weight and a second weight of a first index and a second index respectively, of a plurality of indexes of a database of the e-book reader are determined based on the search intent. At block 830, a first sequence of search results and a second sequence of search results that match the search request are determined by using the first index and the second index respectively. At block 840, at least a portion of search results in the first sequence of search results and the second sequence of search results are provided based on the first weight and the second weight.

According to an example implementation of the present disclosure, the identifying the search intent of the user based on the search request includes: determining, based on the search request and by using an intent identification model, at least one data item that the user expects to search for.

According to an example implementation of the present disclosure, the database includes at least one of the following data items: a character in an e-book, a main character in the e-book, a time in the e-book, a place in the e-book, an event in the e-book, a title in the e-book, a plot in the e-book, a paragraph in the e-book, a key paragraph in the e-book, a bookmark in the e-book, a note in the e-book, usage history data of the e-book, and comment data of the e-book; and an index in the plurality of indexes is an index created according to a data item in the database.

According to an example implementation of the present disclosure, determining the first weight of the first index includes: determining at least one match degree between the data item of the first index and the at least one data item; and determining the first weight based on the at least one match degree.

According to an example implementation of the present disclosure, providing at least the portion of search results in the first sequence of search results and the second sequence of search results includes: for a target search result in the first sequence of search results and the second sequence of search results, determining a global position of the target search result based on a local position of the target search result in the first sequence of search results or in the second sequence of search results, and the first weight and the second weight; and presenting the target search result in global search results for responding to the search request based on the global position.

According to an example implementation of the present disclosure, the database includes at least a portion of the following data ranges: an e-book, an audio e-book, information of the e-book, usage history data of the e-book, bookmark data in the e-book, and comment data of the e-book, and the method further includes: determining a search range of the search request from the plurality of data ranges based on context information of the user inputting the search request; and determining the first sequence of search results and the second sequence of search results that match the search request includes: determining, in the search range, the first sequence of search results and the second sequence of search results that match the search request.

According to an example implementation of the present disclosure, the method further includes: in response to detecting a user interaction of the user for a target search result in the at least the portion of search results, providing detailed data including the target search result.

According to an example implementation of the present disclosure, the method further includes: in response to detecting a close request for closing the detailed data, returning a page for providing the at least the portion of search results.

According to an example implementation of the present disclosure, the plurality of indexes are updated in response to data updating in the database.

According to an example implementation of the present disclosure, at least one index involved in the data updating in the plurality of indexes is updated, and the at least one index is updated based on at least one of the following: a full update mode and an incremental update mode.

### Example Apparatus and Device

The specific details of the method for searching data have been described above. According to an exemplary implementation of the present disclosure, there is provided an apparatus for searching data in an e-book reader. FIG. 9 shows a block diagram of an apparatus 900 for searching data in an e-book reader according to some implementations of the present disclosure. The apparatus 900 includes: an identification module 910, configured to, in response to a search request, identify a search intent of a user based on the search request; a weight determination module 920, configured to determine, based on the search intent, a first weight and a second weight of a first index and a second index respectively, of a plurality of indexes of a database of the e-book reader; a sequence determination module 930, configured to determine, by using the first index and the second index respectively, a first sequence of search results and a second sequence of search results that match the search request; and a providing module 940, configured to provide at least a portion of search results in the first sequence of search results and the second sequence of search results based on the first weight and the second weight.

According to an example implementation of the present disclosure, the identification module includes: an intent identification module, configured to determine, based on the search request and by using an intent identification model, at least one data item that the user expects to search for.

According to an example implementation of the present disclosure, the database includes at least one of the following data items: a character in an e-book, a main character in the e-book, a time in the e-book, a place in the e-book, an event in the e-book, a title in the e-book, a plot in the e-book, a paragraph in the e-book, an important paragraph in the e-book, a bookmark in the e-book, a note in the e-book, usage history data of the e-book, and comment data of the e-book; and an index in the plurality of indexes is an index created according to a data item in the database.

According to an example implementation of the present disclosure, the weight determination module includes: a matching degree determination module, configured to determine at least one match degree between the data item of the first index and the at least one data item; and a determination module based on the match degree, configured to determine the first weight based on the at least one match degree.

According to an example implementation of the present disclosure, the providing module includes: a position determination module, configured to, for a target search result in the first sequence of search results and the second sequence of search results, determine a global position of the target search result based on a local position of the target search result in the first sequence of search results or in the second sequence of search results, and the first weight and the second weight; and a presentation module, configured to present the target search result in global search results for responding to the search request based on the global position.

According to an example implementation of the present disclosure, the database includes at least a portion of of the following data ranges: an e-book, an audio e-book, information of the e-book, usage history data of the e-book, bookmark data in the e-book, and comment data of the e-book, and the apparatus further includes: a range determination module, configured to determine, based on context information of the user inputting the search request, a search range of the search request from the plurality of data ranges; and the sequence determination module includes: a determination-based-on-range module, configured to determine, in the search range, the first sequence of search results and the second sequence of search results that match the search request.

According to an example implementation of the present disclosure, the apparatus further includes: a data providing module, configured to, in response to detecting a user interaction of the user for a target search result in the at least the portion of search results, provide detailed data including the target search result.

According to an example implementation of the present disclosure, the apparatus further includes: a return module, configured to, in response to detecting a close request for closing the detailed data, return a page for providing the at least the portion of search results.

According to an example implementation of the present disclosure, the plurality of indexes are updated in response to data updating in the database.

According to an example implementation of the present disclosure, at least one index involved in the data updating in the plurality of indexes is updated, and the at least one index is updated based on at least one of the following: a full update mode and an incremental update mode.

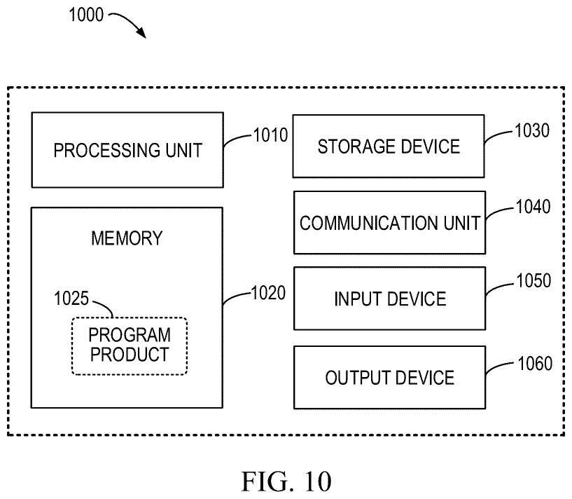

FIG. 10 shows a block diagram of an electronic device 1000 in which various implementations of the present disclosure may be implemented. It should be understood that the electronic device 1000 shown in FIG. 10 is merely an example, and should not constitute any limitation to the function and scope of the implementations described herein. The electronic device 1000 shown in FIG. 10 may be used to implement the method described above.

As shown in FIG. 10, the electronic device 1000 is in the form of a general-purpose computing device. Components of the electronic device 1000 may include, but are not limited to, one or more processors or processing units 1010, a memory 1020, a storage device 1030, one or more communication units 1040, one or more input devices 1050, and one or more output devices 1060. The processing unit 1010 may be a physical or virtual processor and may execute various processes according to programs stored in the memory 1020. In a multi-processor system, a plurality of processing units execute computer-executable instructions in parallel to improve the parallel processing capability of the electronic device 1000.

The electronic device 1000 typically includes a plurality of computer storage media. Such media may be any available media accessible by the electronic device 1000, including but not limited to volatile and non-volatile media, and removable and non-removable media. The memory 1020 may be a volatile memory (for example, a register, cache, Random Access Memory (RAM)), a non-volatile memory (for example, a Read-Only Memory (ROM), Electrically Erasable Programmable Read-Only Memory (EEPROM), flash memory), or some combination thereof. The storage device 1030 may be a removable or non-removable medium, and may include a machine-readable medium such as a flash drive, a disk, or any other medium, which may be used to store information and/or data and may be accessed in the electronic device 1000.

The electronic device 1000 may further include additional removable/non-removable, volatile/non-volatile storage media. Although not shown in FIG. 10, a disk drive for reading from or writing to a removable, non-volatile disk (such as a “floppy disk”) and an optical disk drive for reading from or writing to a removable, non-volatile optical disk may be provided. In these cases, each drive may be connected to a bus (not shown) by one or more data medium interfaces. The memory 1020 may include a computer program product 1025 having one or more program modules configured to perform various methods or actions of various implementations of the present disclosure.

The communication unit 1040 implements communication with other electronic devices through a communication medium. Additionally, the functions of components of the electronic device 1000 may be implemented by a single computing cluster or a plurality of computing machines, which may communicate through communication connections. Therefore, the electronic device 1000 may operate in a networked environment using a logical connection with one or more other servers, network personal computers (PCs), or another network node.

The input device 1050 may be one or more input devices, such as a mouse, a keyboard, a trackball, and the like. The output device 1060 may be one or more output devices, such as a display, a speaker, a printer, and the like. The electronic device 1000 may also communicate with one or more external devices (not shown) as required through the communication unit 1040, such as a storage device, a display device, and the like, communicate with one or more devices that enable a user to interact with the electronic device 1000, or communicate with any device (for example, a network card, a modem, etc.) that enables the electronic device 1000 to communicate with one or more other electronic devices. Such communication may be performed via an input/output (I/O) interface (not shown).

According to some implementations of the present disclosure, there is provided a computer-readable storage medium having computer-executable instructions stored thereon, where the computer-executable instructions are executed by a processor to implement the method described above. According to some implementations of the present disclosure, there is also provided a computer program product stored tangibly on a non-transitory computer-readable medium and including computer-executable instructions, and the computer-executable instructions are executed by a processor to implement the method described above. According to some implementations of the present disclosure, there is provided a computer program product having a computer program stored thereon, and the method described above is implemented when the program is executed by a processor.

Various aspects of the present disclosure are described herein with reference to flowcharts and/or block diagrams of methods, apparatuses, devices, and computer program products according to implementations of the present disclosure. It should be understood that each block of the flowchart and/or block diagram and a combination of blocks in the flowchart and/or block diagram may be implemented by computer-readable program instructions.

These computer-readable program instructions may be provided to a processing unit of a general-purpose computer, a special-purpose computer, or another programmable data processing apparatus to produce a machine, such that when these instructions are executed by the processing unit of the computer or another programmable data processing apparatus, a device for implementing the functions/acts specified in one or more blocks in the flowchart and/or block diagram is generated. These computer-readable program instructions may also be stored in a computer-readable storage medium. These instructions enable a computer, a programmable data processing apparatus, and/or another device to work in a specific manner. Therefore, a computer-readable medium storing the instructions includes a product manufactured, which includes instructions for implementing various aspects of the functions/acts specified in one or more blocks in the flowchart and/or block diagram.

The computer-readable program instructions may be loaded onto a computer, another programmable data processing apparatus, or another device, so that a series of operation steps are performed on the computer, another programmable data processing apparatus, or another device to generate a computer-implemented process, so that the instructions executed on the computer, another programmable data processing apparatus, or another device implement the functions/acts specified in one or more blocks in the flowchart and/or block diagram.

The flowcharts and block diagrams in the accompanying drawings show a possible system architecture, functions, and operations of the system, the method, and the computer program product according to various implementations of the present disclosure. In this regard, each block in the flowchart or block diagram may represent a module, program segment, or part of an instruction, and the module, program segment, or part of an instruction contains one or more executable instructions for implementing the specified logical functions. In some alternative implementations, the functions marked in the blocks may also occur in an order different from that marked in the accompanying drawings. For example, two consecutive blocks may actually be performed substantially in parallel, or they may sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or acts, or may be implemented by a combination of dedicated hardware and computer instructions.

The various implementations of the present disclosure have been described above. The foregoing descriptions are exemplary, not exhaustive, and are not limited to the disclosed implementations. Many modifications and changes are obvious to those of ordinary skill in the art without departing from the scope and spirit of the described implementations. The selection of terms used herein is intended to best explain the principles of the implementations, the practical application or improvement of the technology in the market, or to enable other ordinary skilled persons in the art to understand the implementations disclosed herein.

What is claimed is:

1. A method for searching data in an e-book reader, comprising:
in response to a search request, identifying a search intent of a user based on the search request;
determining, based on the search intent, a first weight and a second weight of a first index and a second index respectively, of a plurality of indexes of a database of the e-book reader;
determining, by using the first index and the second index respectively, a first sequence of search results and a second sequence of search results that match the search request; and
providing at least a portion of search results in the first sequence of search results and the second sequence of search results based on the first weight and the second weight.

2. The method according to claim 1, wherein identifying the search intent of the user based on the search request comprises: determining, based on the search request and by using an intent identification model, at least one data item that the user expects to search for.

3. The method according to claim 2, wherein the database comprises at least one of the following data items: a character in an e-book, a main character in the e-book, a time in the e-book, a place in the e-book, an event in the e-book, a title in the e-book, a plot in the e-book, a paragraph in the e-book, a key paragraph in the e-book, a bookmark in the e-book, a note in the e-book, usage history data of the e-book, and comment data of the e-book; and an index in the plurality of indexes is an index created according to a data item in the database.

4. The method according to claim 3, wherein determining the first weight of the first index comprises:
determining at least one match degree between a data item of the first index and the at least one data item; and
determining the first weight based on the at least one match degree.

5. The method according to claim 1, wherein providing at least the portion of search results in the first sequence of search results and the second sequence of search results comprises: for a target search result in the first sequence of search results and the second sequence of search results,
determining a global position of the target search result based on a local position of the target search result in the first sequence of search results or in the second sequence of search results, and the first weight and the second weight; and
presenting, based on the global position, the target search result in global search results for responding to the search request.

6. The method according to claim 1, wherein the database comprises at least a portion of the following: a plurality of data ranges: an e-book, an audio e-book, information of an e-book, usage history data of an e-book, bookmark data in an e-book, and comment data of an e-book, and the method further comprises:
determining a search range of the search request from the plurality of data ranges based on context information of the user inputting the search request; and wherein determining the first sequence of search results and the second sequence of search results that match the search request comprises: determining, in the search range, the first sequence of search results and the second sequence of search results that match the search request.

7. The method according to claim 1, further comprising: in response to detecting a user interaction of the user for a target search result in the at least the portion of search results, providing detailed data including the target search result.

8. The method according to claim 7, further comprising: in response to detecting a close request for closing the detailed data, returning to a page for providing the at least the portion of search results.

9. The method according to claim 1, wherein the plurality of indexes are updated in response to data updating in the database.

10. The method according to claim 9, wherein at least one index of the plurality indexes involved in the data updating in the plurality of indexes is updated, and the at least one index is updated based on at least one of the following: a full update mode and an incremental update mode.

11. An electronic device, comprising:
at least one processing unit; and
at least one memory coupled to the at least one processing unit and storing instructions for execution by the at least one processing unit, the instructions, when executed by the at least one processing unit, causing the electronic device to perform a method for searching data in an e-book reader, comprising:
in response to a search request, identifying a search intent of a user based on the search request;
determining, based on the search intent, a first weight and a second weight of a first index and a second index respectively, of a plurality of indexes of a database of the e-book reader;
determining, by using the first index and the second index respectively, a first sequence of search results and a second sequence of search results that match the search request; and
providing at least a portion of search results in the first sequence of search results and the second sequence of search results based on the first weight and the second weight.

12. The electronic device according to claim 11, wherein identifying the search intent of the user based on the search request comprises: determining, based on the search request and by using an intent identification model, at least one data item that the user expects to search for.

13. The electronic device according to claim 12, wherein the database comprises at least one of the following data items: a character in an e-book, a main character in the e-book, a time in the e-book, a place in the e-book, an event in the e-book, a title in the e-book, a plot in the e-book, a paragraph in the e-book, a key paragraph in the e-book, a bookmark in the e-book, a note in the e-book, usage history data of the e-book, and comment data of the e-book; and an index in the plurality of indexes is an index created according to a data item in the database.

14. The electronic device according to claim 13, wherein determining the first weight of the first index comprises:
determining at least one match degree between a data item of the first index and the at least one data item; and
determining the first weight based on the at least one match degree.

15. The electronic device according to claim 11, wherein providing at least the portion of search results in the first sequence of search results and the second sequence of search results comprises: for a target search result in the first sequence of search results and the second sequence of search results,
determining a global position of the target search result based on a local position of the target search result in the first sequence of search results or in the second sequence of search results, and the first weight and the second weight; and
presenting, based on the global position, the target search result in global search results for responding to the search request.

16. The electronic device according to claim 11, wherein the database comprises at least a portion of the following: a plurality of data ranges: an e-book, an audio e-book, information of an e-book, usage history data of an e-book, bookmark data in an e-book, and comment data of an e-book, and the method further comprises:
determining a search range of the search request from the plurality of data ranges based on context information of the user inputting the search request; and wherein determining the first sequence of search results and the second sequence of search results that match the search request comprises: determining, in the search range, the first sequence of search results and the second sequence of search results that match the search request.

17. The electronic device according to claim 11, the method further comprises: in response to detecting a user interaction of the user for a target search result in the at least the portion of search results, providing detailed data including the target search result.

18. The electronic device according to claim 17, the method further comprises: in response to detecting a close request for closing the detailed data, returning to a page for providing the at least the portion of search results.

19. The electronic device according to claim 11, wherein the plurality of indexes are updated in response to data updating in the database.

20. A non-transitory computer-readable storage medium having a computer program stored thereon, the computer program, when executed by a processor, causing the processor to implement a method for searching data in an e-book reader, comprising:
in response to a search request, identifying a search intent of a user based on the search request;
determining, based on the search intent, a first weight and a second weight of a first index and a second index respectively, of a plurality of indexes of a database of the e-book reader;
determining, by using the first index and the second index respectively, a first sequence of search results and a second sequence of search results that match the search request; and
providing at least a portion of search results in the first sequence of search results and the second sequence of search results based on the first weight and the second weight.
